(19) United States
(12) Patent Application Publication
(10) Pub. No.: US 2009/0197710 A1
(43) Pub. Date: Aug. 6, 2009

(54) MARKING SYSTEM FOR SPORT AREAS

(75) Inventor: Cornelis Reinder Ronda, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/298,970

(22) PCT Filed: Apr. 24, 2007
(86) PCT No.: PCT/IB07/51502

§ 371 Date: Oct. 29, 2008

(30) Foreign Application Priority Data
May 2, 2006 (EP) 06113400.3
Jun. 14, 2006 (EP) 06115431.6

(51) Int. Cl. A63C 19/06; H05B 37/00; H05B 37/02

(52) U.S. Cl. 473/490; 315/314; 315/154

(57) ABSTRACT

The invention relates to a marking system comprising lighting devices, for example LEDs (11), that are used on a sport area (1) to indicate demarcations (100) of different games. By activating the associated lighting devices (11), the demarcations (100) of a particular game can selectively be made visible. The marking system may further comprise detection devices that can detect the occurrence of certain game events. Thus photodetectors (12) may for example detect if a ball (2) crosses a demarcation (100). A controller (13) may then activate the lighting devices (11) or separate signaling devices (14, 15) to indicate the detected event. The controller (13) may further communicate wirelessly with persons on the sport area, particularly with the referee to assist his/her decisions.

The invention relates to a marking system for a sport area, to a sport area comprising such a marking system, and to the use of a lighting device as a marking system for a sport area.

Sport areas comprise sport fields, especially indoors, are generally used for many different kinds of sports. For this reason, these sports fields contain many different demarcations, painted on the ground in different colors. Especially when fast decisions need to be taken (either by the players or the referees), this is a disadvantage. In addition, the people watching the sports might also get confused. Outdoor sports fields are generally used for one purpose only, mainly due to the fact that only one kind of demarcation can be used. Especially in urban areas, this results in the use of very expensive pieces of land for sport purposes. The U.S. Pat. No. 6,699,137 B2 proposes in this respect to make a highly frequented golf course usable at night by illuminating it in the dark with lighting devices like elongated strips of light emitting diodes (LEDs).

Based on this situation it was an object of the present invention to provide means for a clear and flexible marking of a sport area.

This objective is achieved by a marking system according to claim 1, by a sport area according to claim 12, and by a use according to claim 13 to 15. Preferred embodiments are disclosed in the dependent claims.

According to its first aspect, the invention relates to a marking system for a sport area, wherein the term “sport area” shall denote in the present text any (indoor or outdoor) sports field or playing field that has a size and structure according to the rules of a game that can be played there. The term “game” shall comprises any competition performed by rules, which may particularly comprise soccer, football, handball, basketball, volleyball, field hockey, tennis, badminton, water sports, ice skating etc. This list is not conclusive but applies to all kinds of sports comprising team sports or sports like any kind of track-and-field athletics, swimming competitions or winter sports like ice skating, skiing etc. where demarcation lines are used.

The marking system comprises at least one lighting device for emitting light, wherein said lighting device is coupled to a controller which can selectively activate and deactivate it, and wherein the lighting device is disposed at the position of a demarcation according to rules of a game that can be played on the sport area. The demarcation may particularly have the form of a line or sometimes also of a point or an area. Preferably, one or more lighting devices are disposed at all demarcations that belong to a certain game.

With a marking system of the aforementioned kind, demarcations of a game can be made clearly visible by activating the lighting device(s) at the associated positions. Besides better visibility, a further advantage of such a marking system is that it is much less prone to wear than usual demarcation lines painted on the ground.

According to a further development of the invention, the marking system comprises at least two lighting devices that are coupled to the controller and that can be activated by the controller to selectively indicate demarcations of different games. The same sport area can thus be used for playing different games (at different times, or, if the sport area provides separate regions, also simultaneously). As the difference between activated and deactivated lighting devices is clearly visible, the players, referees and spectators of a game can recognize the demarcations that are in force without doubt. This is a considerable advantage with respect to usual demarcations painted on the ground, which look always the same whether in force during a certain game or not.

The marking system may further optionally comprise at least one a signaling device, for example a signal light or a loudspeaker, for indicating dynamic information (particularly information that relates to a game taking place on the sport area), wherein the signaling device is preferably coupled to the controller of the marking system. The term “dynamic information” shall refer here and in the following to information that is time-dependent (e.g. time out in a game, end of a game, begin of half-time, advertisement etc.) and/or that depends on events occurring during a game (e.g. goal, ball is out etc.). The term “dynamic information” shall also refer to dynamic information to the public about the relative position and/or the difference in speed in case of sports (or games) like running tournaments, ice skating, swimming matches, row matches etc.

According to another embodiment of the invention, the controller is adapted to control the lighting device according to different illumination patterns that represent dynamic information, particularly information about a game. The illumination patterns may for example comprise a blinking of the lighting device or its illumination with different colors. Thus the boundaries of a goal may for example blink if the ball has hit the goal, or the touchline may (completely or locally) change its color when the ball has crossed it during a soccer game. The lighting device can therefore be used in a very intuitive way to indicate events that are related to the demarcations of a sport area.

The controller may optionally be coupled to an input device for receiving dynamic information about a game, which can then be taken into account during the control of the lighting device. If the referee has for example decided that a goal has been shot or that the ball was in the out, the controller can indicate this to everybody as described above by a separate signaling device or by the lighting device itself. The input device is preferably adapted for receiving wireless signals, because the input can then be provided by players or a referee taking part in a game on the sport area.

In a further development of the invention, the marking system comprises at least one detection device for automatically detecting the occurrence of at least one particular game event. This game event may especially be related to the demarcations of the sport area and may for instance comprise the crossing of a demarcation by an object (e.g. a player or a ball). By the integration of such a detection device, the marking system can additionally acquire a function as a decision support system for the referee. Thus the crossing of a touchline by a ball can for example securely be detected even if the referee (or a linesman) could not see it himself/herself.

The marking system may further comprise at least one identifier that can be carried by an object, for example a ball used in a game, and that can be detected by the aforementioned detection device. The identifier may for example be a Radio Frequency Identification (RFID) transponder that can be detected by an appropriate reader in the detection device.

The marking system may further comprise a sender for a wireless communication of the detection of a game event to a receiver. Such a receiver may particularly be carried by persons that take actively part in the game on the sport area, e.g. the referee, to inform them about the detected events.

There are many possibilities for constructing the lighting device of the marking system. Preferably, the lighting device comprises at least one anorganic or organic light emitting diode (LED/OLED). LEDs are suitable for this application as they are operated at low voltage (safety), have long operational lifetime (maintenance), and are readily available in many colors (for many different games etc.), can be used in light mixture schemes and can be operated in many different modes, without affecting lifetimes considerably.

The invention further relates to a sport area that comprises a marking system of the kind described above. Moreover, it relates to the use of lighting devices as indication of a demarcation according to rules of the game that can be played on a sport area. The sport area comprises a sport stadium, a playing field, a track-and-field arena, a cycling arena, a ice arena or a swimming arena.

The aforementioned sport area and the use rely on similar features as the lighting device described above. In one embodiment the demarcation system is arranged in or under water. In another embodiment the demarcation system provides information about at least the fastest person. The term “information” comprises an indication about distance to the fastest person or the speed difference to the fastest person or an indication about the virtual position during a race or game. As an example, the information may be provided by a dynamic line indicating a virtual position of a person. For more information on details, advantages and further developments of them reference is therefore made to the description of said lighting device.

These and other aspects of the invention will be apparent from and elucidated with reference to the embodiment(s) described hereinafter. These embodiments will be described by way of example with the help of the accompanying drawings in which:

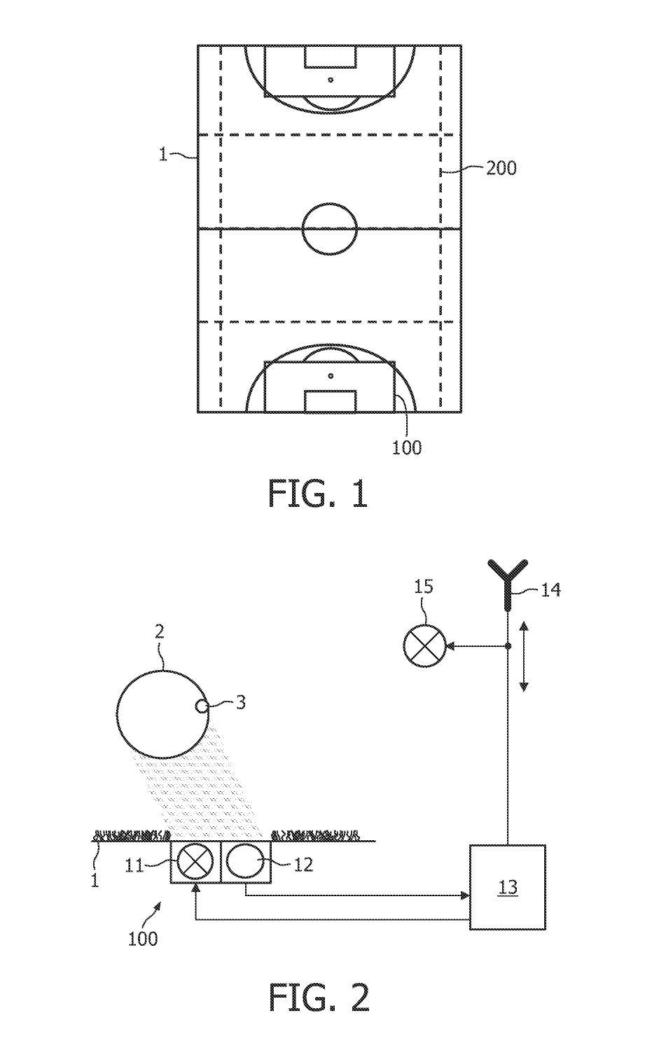

FIG. 1 shows a top view of a sport area comprising demarcations for two different games;

FIG. 2 shows a schematic cross section of a marking system according to the present invention.

Like reference numbers in the Figures refer to identical or similar components.

FIG. 1 shows in a top view an exemplary (indoor or outdoor) sport area 1. The sport area 1 carriers the demarcations 100 of soccer (solid black lines) and, superimposed to this, the demarcations 200 of field hockey (gray lines). Typical indoor sport areas are provided with still more demarcations to allow their use for many different games, wherein the demarcations are usually painted in different colors on the ground. This makes it however hard to see for players, referees and spectators which demarcation is in force during an actual game.

The present invention proposes in this respect to use lighting devices as demarcations for different games. The lighting devices may preferably be realized by elongated strings of LEDs. LEDs are compact light sources that are available in many different colors. Due to their long operational lifetime, LEDs can be applied under conditions where replacement is difficult. In addition, they can be made color tunable and can be made compact and bright.

The marking system according to the present invention comprises at least two lighting devices (i.e. sets of LEDs) that are disposed along the demarcations 100 and 200, respectively, of at least two different games on the sport area 1. It is then possible to activate during a game only the appropriate lighting device, for example the LEDs that highlight the demarcations 100 of a soccer game, and to let the other lighting device remain dark.

FIG. 2 shows an enlarged detail of a further developed marking system according to the present invention. The Figure shows one LED 11 of a large number of LEDs that are embedded as a string into the ground of a sport area 1 along the demarcation 100 of a certain game, e.g. soccer. The LED 11 is connected to a controller 13 that can selectively activate or deactivate the LED 11. Different colors can be obtained by RGB LED (which, in turn, allow many different additional colors) units or by individual single color LEDs.

The marking system further comprises photodetectors 12 that are arranged adjacent to the LEDs 11 and that are also coupled to the controller 13. Additional photodetector strings may for example be positioned in the goals. The photodetectors 12 can detect a (fast) change of their illumination that may for example be caused by the shade of a ball 2 passing over the demarcation 100. Based on the signals of the photodetector(s) 12, the controller 13 can therefore detect the event “object crossing the demarcation 100”. Preferably, the controller 13 further can comprise software that can distinguish the playing object (e.g. the ball 2) crossing the demarcation 100 from players or other objects crossing it.

In an alternative embodiment, the ball 2 (or any other object of interest) may be provided with an identifier (e.g. a RFID transponder 3) that can communicate with a suitable detector 12 (e.g. a RF receiver) at the demarcation 100. This allows the detection and additionally the secure identification of an object passing the demarcation 100.

When the controller 13 detects the occurrence of a certain event during a game, for example the ball 2 crossing the demarcation 100, it may activate the LEDs 11 according to a certain illumination pattern to make this detection visible for everybody. Thus the controller 13 might for example flash the LEDs 11 for a certain time (either locally at the position where the ball 2 crossed or in a larger area), or it may temporarily change their color. The controller 13 may further be coupled to a signaling device 15, for example a dedicated LED, that can be activated when a certain event has been detected.

The controller 13 may further be coupled to an antenna 14 to be able to receive wireless inputs and to send wirelessly information to a receiver on the sport area. Thus the controller 13 may for example receive a signal from the referee indicating a certain decision (e.g. goal/no goal), wherein the controller 13 may then make said decision visible by an appropriate control of the LEDs 11 or the signaling LED 15. Moreover, the controller 13 may communicate the detection of a certain event (goal or not, ball/puck etc. just in or out, etc.) wirelessly via the antenna 14 to the referee on the sport area. The use of the LEDs 11 together with the photodetectors 11 thus enables to create a referee decision support system, wherein the referee can count on LEDs and detection systems to assist him or her in the decisions to be taken.

In summary, the invention describes the use of LEDs and photodetectors in sport fields, where they can replace current demarcations. This can avoid (especially indoors) confusing demarcations and reduce (especially outdoors) the need of expensive pieces of land to be used. The LEDs can further be used to visually indicate the nature of referee decisions (goal, end of game, etc.), other game related information, or supplementary information like advertisement and/or information before and after games and during breaks. This greatly enhances the watching experience. Moreover, the use of LEDs and photodetectors or other means of communication enables to provide referee support systems.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

LEDs, which are low voltage devices, can be used to create safely and clearly visible demarcations at e.g. the water surface. In case of water team sports, the demarcations can be used in exactly the same way as given above for sport fields.

In case of running tournaments, ice skating, swimming matches, row matches and the like, the demarcations using which individual tracks can be defined contain, according to the present invention, LEDs. Apart from the decorative element, such demarcations can also provide information to the public:
The public can be informed about the relative position of each of the participants during the race (especially useful when the differences are small, or when e.g. runners are running in different orbits), by assigning a specific colour to the LEDs indicating the track in which the leading person is (persons are) or any other clearly visible means.
The Public can be informed about differences in speed in the actual race and races, which have been performed earlier, for instance by a ‘running’ LED light or any other kind of clearly visible means. In this way, the public can e.g. compare the actual race with earlier races in the tournament or e.g. with an important record, e.g. the world record.
   Ice tournaments in general consist of more than one skating distance. Then, the device according to the invention can be used to indicate the position where the skater has to be to e.g. take a better position in the general classification or indicate how many positions he gains or loses virtually at any time by using a number of running lights

In all these cases, communication can e.g. be by near field communication.

1. A marking system for a sport area (1), comprising at least one lighting device (11) that is coupled to a controller (13) for selectively activating it and that is disposed at the position of a demarcation (100, 200) of a game that can be played on the sport area (1).

2. The marking system according to claim 1,
characterized in that it comprises a plurality of lighting devices (11) that can selectively be activated by the controller (13) to indicate demarcations (100, 200) of different games.

3. The marking system according to claim 1,
characterized in that it comprises at least one signaling device (15) for indicating dynamic information, particularly information about a game on the sport area (1).

4. The marking system according to claim 1,
characterized in that the controller (13) is adapted to control the lighting device (11) according to different illumination patterns representing dynamic information, particularly information about a game on the sport area (1).

5. The marking system according to claim 1,
characterized in that the controller (13) is coupled to an input device, preferably a wireless input device (14), for receiving dynamical information about a game on the sport area (1).

6. The marking system according to claim 1,
characterized in that it comprises at least one detection device (12) for detecting the occurrence of a particular game event.

7. The marking system according to claim 6,
characterized in that the game event comprises the crossing of a demarcation (100, 200) by an object (2).

8. The marking system according to claim 6,
characterized in that the detection device comprises a photodetector (12) for detecting changes in illumination caused by a crossing object (2).

9. The marking system according to claim 6,
characterized in that it comprises at least one identifier (3) that can be carried by an object (2) and that can be detected by the detection device (12).

10. The marking system according to claim 6,
characterized in that it comprises a sender (14) for a wireless communication of the detection of a game event to a receiver on the sport area (1).

11. The marking system according to claim 1,
characterized in that the lighting device comprises at least one LED (11) or organic LED.

12. A sport area (1), comprising a marking system according to claim 1, wherein the sport area comprises a sport stadium, a playing field, a track-and-field arena, a cycling arena, a ice arena or a swimming arena.

13. Use of a lighting device (11) as indication of a demarcation (100, 200) of a game that can be played on a sport area (1).

14. Use of a lighting device (11) as claimed in claim 13, wherein the demarcation system is arranged in or under water.

15. Use of a demarcation system according to claim 1 wherein the demarcation system provides information about at least the fastest person.
